(19) United States
(12) Patent Application Publication
(10) Pub. No.: US 2004/0041769 A1
(43) Pub. Date: Mar. 4, 2004

(54) Display apparatus

(76) Inventors: Junichi Yamashita, Tokyo (JP); Katsuhide Uchino, Kanagawa (JP)

Correspondence Address: ROBERT J. DEPKE LEWIS T. STEADMAN, HOLLAND & KNIGHT LLC, 131 SOUTH DEARBORN, 30TH FLOOR, CHICAGO, IL, 60603, US

(21) Appl. No.: 10/450,550

(22) PCT Filed: Oct. 16, 2002
(86) PCT No.: PCT/JP02/10756

(30) Foreign Application Priority Data
Oct. 17, 2001 (JP) P2001-319263

(51) Int. Cl. G09G 3/36

(52) U.S. Cl. 345/93

(57) ABSTRACT

A display device so improved as to reduce the size of a peripheral driving circuit incorporated therein. The display device comprises, on one substrate, a pixel array (4), a vertical driving circuit (5) for sequentially selecting pixels (P) via gate lines (G), and a horizontal driving circuit (6) for writing image signals in the selected pixels (P) via signal lines (S). The vertical driving circuit (5) has shift registers (S/R) so disposed that one stage thereof corresponds to at least two gate lines (G), and outputting shift pulses sequentially from the respective stages thereof; gate circuits (5g) for generating drive pulses by extracting, in response to the shift pulses, the clock pulses supplied thereto externally, and outputting the drive pulses to the gate lines (G) to thereby execute sequential selection of the the pixels (P); and a shaping means (5z) for shaping the clock pulses previously in accordance with a horizontal blanking pulse supplied externally in synchronism with a horizontal blanking interval, and supplying the shaped clock pulses to the gate circuits (5g).

### TECHNICAL FIELD

The present invention relates to an active matrix type display device represented by a LCD and, more particularly, to the structure of a vertical driving circuit for driving a matrix array of pixels.

### BACKGROUND ART

FIG. 8 is a perspective diagram showing a general structure of an active matrix type display device. As shown in the diagram, the conventional display device has a panel construction comprising a pair of substrates 1, 2 and a liquid crystal 3 held therebetween. A pixel array 4 and a driving circuitry are formed integrally on the lower substrate 1. The driving circuitry is divided into a vertical driving circuit 5 and a horizontal driving circuit 6. And terminals 7 for external connection are formed on the peripheral upper end of the substrate. Each of the terminals 7 is connected to the vertical driving circuit 5 and the horizontal driving circuit 6 via a wiring 8. Gate lines G and signal lines S are formed in the pixel array 4. And at the intersection of these lines, there are formed a pixel electrode 9 and a thin film transistor 10 to drive the pixel electrode 9. A pixel P is configured by a combination of the pixel electrode 9 and the thin film transistor 10. A gate electrode of the thin film transistor 10 is connected to the corresponding gate line G, and the drain region thereof is connected to the corresponding pixel electrode 9, and the source region thereof is connected to the corresponding signal line S, respectively. The gate line G is connected to the vertical driving circuit 5, while the signal line S is connected to the horizontal driving circuit 6. The vertical driving circuit 5 selects the pixels P sequentially via the gate lines G, and the horizontal driving circuit 6 writes image signals in the selected pixels P via the signal lines S.

Recently, reduction of the pixel size is in progress with a trend of achieving a higher minuteness of the LCD. And the vertical driving circuit also needs to be reduced in accordance with such reduction of the pixel size. Generally, the vertical driving circuit consists of shift registers connected in multiple stages each corresponding to the relevant gate line. And pixel rows connected to the corresponding gate lines are selected line-sequentially in response to shift pulses outputted sequentially from the respective stages of the shift registers. However, since advanced reduction of the pixel size eventually narrows the interval between the arrayed gate lines, one stage of the shift register fails to conform with the space of one gate line.

In order to solve this problem, there is currently developed an improved vertical driving circuit, which is termed a decode type vertical driving circuit, where a single-stage shift register is provided for two gate lines. In this decode type vertical driving circuit, clock pulses supplied externally are extracted in response to a shift pulse outputted from a single-stage shift register, and drive pulses for two gate lines are produced. As drive pulses are thus produced from a shift pulse by a clock drive system, there is employed a gate circuit including a logical element. In contrast to a simple vertical driving circuit, the gate circuit used in this decode type vertical driving circuit is rather complicated, and a greater number of logical elements are required per gate line. As a result, such logical elements occupy a large area on the LCD panel. Therefore, the occupied area of the pixel array configuring the display screen is partially limited with a disadvantage of increasing the required surface area for the LCD panel, hence raising another problem to be solved.

### DISCLOSURE OF INVENTION

According to the present invention, external clock pulses are shaped collectively in advance and then are supplied to the vertical driving circuit. Consequently, it becomes possible to curtail the number of logical elements required in the vertical driving circuit, thereby realizing reduction of the vertical driving circuit. More specifically, a NAND of pulses VCK and ENB is taken in a device area separate from the vertical driving circuit, and the pulses VCK obtained from the NAND circuit are used in the vertical driving circuit to eventually halve the number of the required NAND elements in the vertical driving circuit. As a result, the occupied area of the vertical driving circuit can be reduced approximately by 13%, hence achieving narrow framing of the LCD panel.

### BRIEF DESCRIPTION OF DRAWINGS

FIG. 1 is a circuit diagram showing the structure of a display device according to the present invention;

FIG. 2 is a timing chart for describing the operation of the display device shown in FIG. 1;

FIG. 3 is a typical diagram showing an example of a pixel array in the display device of the present invention;

FIGS. 4A, 4B and 4C are typical diagrams for describing the operation of the display device shown in FIG. 3;

FIG. 5 is a circuit diagram showing a reference example of a display device;

FIG. 6 is a timing chart for describing the operation of the reference display device shown in FIG. 5;

FIG. 7A is a typical diagram showing the whole structure of the display device shown in FIG. 1;

FIG. 7B is a typical diagram showing the whole structure of the display device shown in FIG. 5; and

FIG. 8 is a typical perspective diagram showing an example of a conventional display device.

### BEST MODE FOR CARRYING OUT THE INVENTION

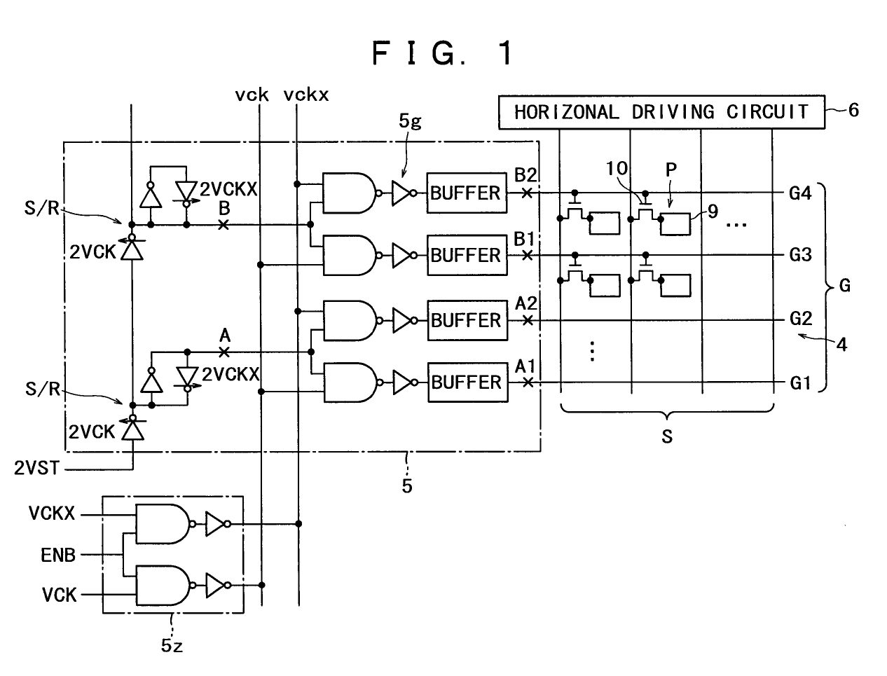

Hereinafter an embodiment of the present invention will be described in detail with reference to the accompanying drawings. FIG. 1 is a circuit diagram showing the concrete structure of a display device according to the present invention. As shown, this display device fundamentally consists of a pixel array 4, a vertical driving circuit 5 and a horizontal driving circuit 6, which are composed integrally of thin film transistors and so forth on one substrate. The pixel array 4 comprises a plurality of gate lines G, a plurality of signal lines S, and pixels P arrayed to form a matrix at the intersections of the gate lines G and the signal lines S. In this example, each pixel P is composed of a pixel electrode 9 and a thin film transistor 10. Although not shown, an opposite electrode is formed at a position opposite to the pixel electrode 9, and a liquid crystal for example is held as an electro-optical substance between the two electrodes. The gate electrode of the thin film transistor 10 is connected to the corresponding gate line G, while the source electrode thereof is connected to the corresponding signal line S, and the drain electrode thereof is connected to the corresponding pixel electrode 9, respectively. The vertical driving circuit 5 selects the individual pixels P sequentially via the relevant gate lines G. In FIG. 1, for the purpose of making the invention better understood with facility, line sequential selection of the gate lines G by the vertical driving circuit 5 is performed upward from the lowest portion of the screen. More concretely, the corresponding row of pixels P corresponding to the first gate line G1 is selected, then the row of pixels P to the second gate line G2 is selected, and thereafter the succeeding pixels P are selected row by row sequentially. The horizontal driving circuit 6 writes image signals, via the corresponding signal lines S, in the pixels P thus selected row by row sequentially, thereby displaying a desired image in the pixel array 4 that constitutes the picture on the screen.

As a particular characteristic item, the vertical driving circuit 5 has a shaping means 5z in addition to shift registers S/R and gate circuits 5g. One stage of each shift register S/R corresponds to at least two gate lines, and shift pulses are outputted sequentially from the individual stages. In the shown example, one stage of the shift register S/R consists of three inverters, wherein one inverter is clock-driven by clock pulses 2VCK supplied externally, and another inverter is clock-driven by clock pulses 2VCKX inputted externally. The pulse 2VCKX is inverse in polarity to the pulse 2VCK, and therefore a symbol X is attached to denote such inversion. This symbol is applied to other clock pulses also. The multi-stage connected shift registers S/R operate in accordance with the clock pulses 2VCK and 2VCKX, and sequentially transfer start pulses 2VST inputted thereto externally, whereby shift pulses A, B . . . are outputted sequentially from the respective stages of the shift registers. In the shown example, the first-stage shift register S/R is provided correspondingly to the first two gate lines G1 and G2, and outputs one shift pulse A to the two gate lines G1 and G2. Similarly, the second-stage shift register S/R is provided correspondingly to the next two gate lines G3 and G4, and outputs a shift pulse B thereto.

The gate circuits 5g extract the externally supplied clock pulses VCK and VCKX in response to the aforementioned shift pulses A, B . . . , then generate drive pulses A1, A2, B1, B2, and output the same to the gate lines G1, G2, G3, G4 . . . to perform line sequential selection of the pixels P. For this purpose, each gate circuit 5g has a series connection of a NAND element, an inverter and a buffer correspondingly to the relevant gate line G. Regarding the first gate line G1 for example, the gate circuit 5g extracts a clock pulse VCK in response to a shift pulse A, and outputs the extracted pulse as a drive pulse A1 to the gate line G1. Similarly, regarding the second gate line G2, the gate circuit 5g extracts an externally supplied clock pulse VCKX in response to a shift pulse A, and outputs the extracted pulse as a drive pulse A2 to the gate line G2.

The shaping means 5z shapes the clock pulses VCK and VCKX previously in response to a horizontal blanking pulse ENB supplied externally in synchronism with a horizontal blanking interval, and then supplies the shaped clock pulses vck ad vckx to the respective stages of the gate circuits 5g. More specifically, each stage of the gate circuits 5g corresponding to the relevant gate line G is supplied with the clock pulses vck and vckx shaped by the shaping means 5v, instead of the clock signals VCK and VCKX inputted directly from the external device. Thus, the clock pulses VCK and VCKX are shaped in advance collectively and then are inputted to the respective stages of the gate circuits 5g, so that it becomes possible to eliminate the shaping process in the gate circuits 5g, hence curtailing the number of the required logical elements. The shaping means 5z is formed in a separate region apart from the shift registers S/R and the gate circuits 5g.

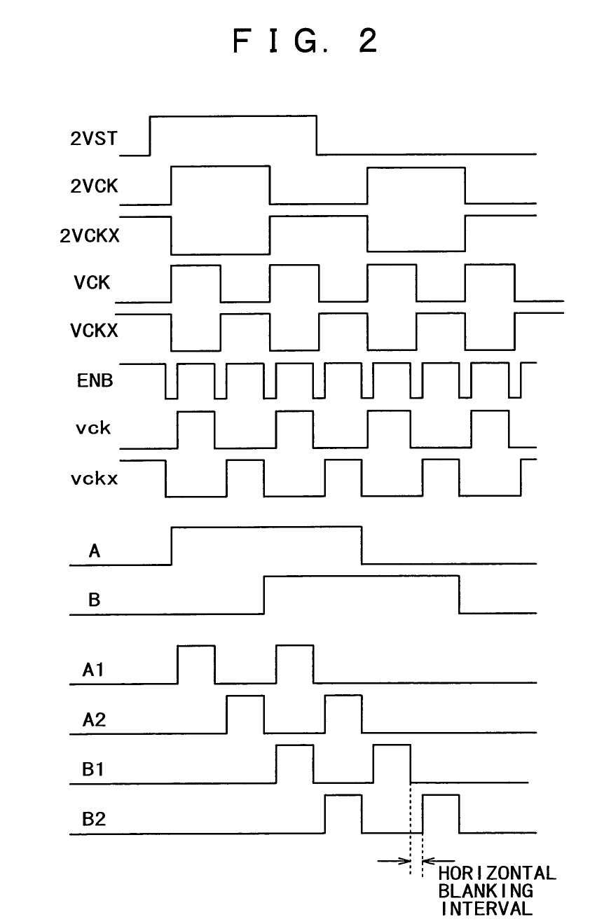

Now the operation of the display device shown in FIG. 1 will be described below with reference to a timing chart of FIG. 2. As mentioned above, the vertical driving circuit is supplied externally with a start pulse 2VST and clock pulses 2VCK, 2VCKX, VCK, VCKX and ENB. Of these pulses, 2VST, 2VCK and 2VCKX are used for operating the shift registers in the vertical driving circuit and producing shift pulses A, B . . . and so forth. Meanwhile VCK and VCKX are used for producing drive pulses A1, A2, B1, B2 . . . and so forth. ENB prescribes the horizontal blanking interval, which temporally partitions the matrix-arrayed pixels row by row.

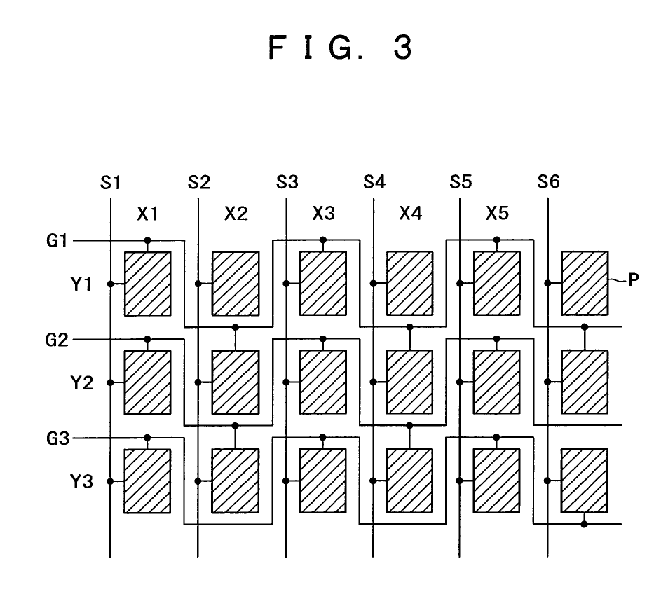

The shaping means 5z consists of two NAND elements and two inverters, and generates vck and vckx by taking a NAND between ENB and each of VCK and VCKX. Meanwhile the shift registers S/R sequentially transfer 2VST in response to 2VCK and 2VCKX to thereby generate shift pulses A, B . . . and so forth. The gate circuit 5g extracts the shaped clock pulses vck and vckx, which are supplied from the shaping means 5z, in accordance with the shift pulses A, B . . . , and then outputs the drive pulses A1, A2, B1, B2 . . . partitioned mutually by the horizontal blanking interval. In this embodiment, the drive pulse outputted to each gate line G includes two pulse components anterior and posterior temporally. Therefore, one gate line is selected twice through one horizontal interval. Accordingly, an image signal is written twice in the corresponding pixel row. The image signal written first is rewritten immediately by the second image signal, so that the picture definition is not affected substantially. Such a twice writing method is adapted particularly for dot line inversion driving thereby contributing toward improvement of the picture definition. As described above, the vertical driving circuit sequentially selects each pixels row by row via the gate lines. And the horizontal driving circuit writes the image signal dot-sequentially in the selected pixel row via the signal line. When driving the liquid crystal, it is necessary to invert the polarity of the image signal prior to writing the same in each pixel, and the aforementioned dot line inversion driving for example is executed as one method. FIG. 3 shows an exemplary pixel array adapted for dot line inversion driving. As shown in this diagram, the pixels P are so arrayed as to form a matrix, wherein the vertical pixel columns are denoted by X1, X2, . . . and so forth, while the horizontal pixel rows are denoted by Y1, Y2, . . . and so forth. An individual pixel P to be specified is expressed as (X1, Y1) for example. This pixel signifies the one positioned on the first column X1 and the first row Y1. In the dot line inversion driving, the pixels P connected to the same gate line G are distributed alternately per column between mutually adjacent rows. Regarding the gate line G1 for example, the pixel (X1, Y1) belongs to the row Y1, the next pixel (X2, Y2) belongs to the row Y2, the succeeding pixel (X3, Y1) belongs to the row Y1, and further the pixel (X4, Y2) belongs to the row Y2, respectively.

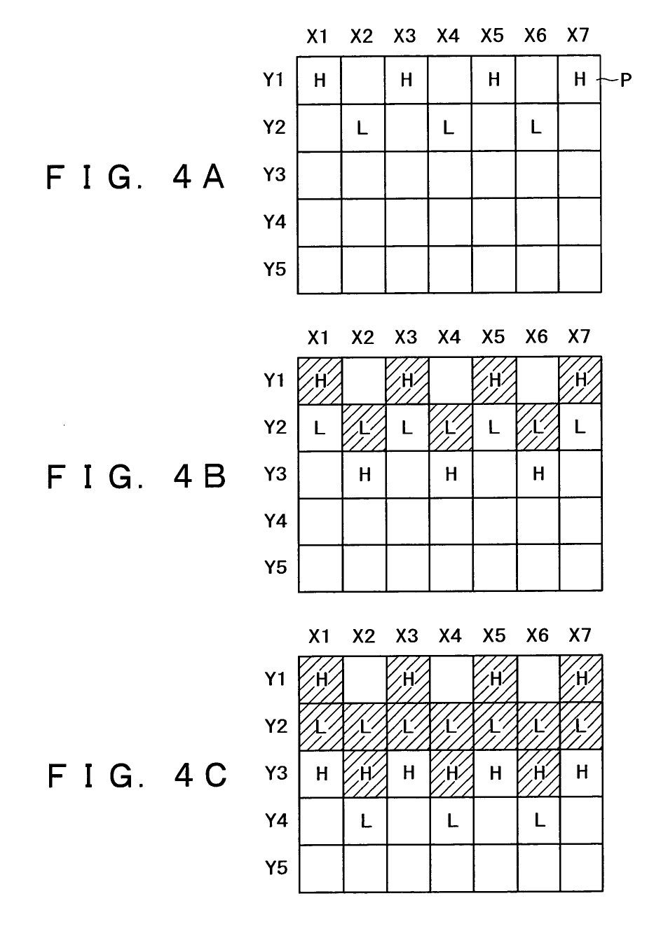

Referring now to FIGS. 4A-4C, an explanation will be given on the dot line inversion driving for the pixel array shown in FIG. 3. As shown in FIG. 4A, upon selection of the first gate line G1, an image signal is written in the pixels P connected thereto. As described, the selected pixels are distributed alternately to the pixel rows Y1 and Y2. And an image signal of one polarity (H) is written in the pixels P distributed to the pixel row Y1, while an image signal of an opposite polarity (L) is written in the pixels P distributed to the next pixel row Y2. It can be said that, from a different point of view, the image signal polarity is inverted with respect to the odd columns (X1, X3 . . . ) and the even columns (X2, X4,).

After completion of selecting the gate line G1, the operation proceeds to selection of the next gate line G2, as shown in FIG. 4B. Similarly to the above, the pixels are distributed alternately to the rows Y2 and Y3. The pixels where the image signals have already been written are hatched in the diagrams to indicate distinction. This time also, the image signal is written in the corresponding pixels while being inverted alternately between the columns. In FIGS. 4A and 4B, the polarity is inverse to each other. Therefore the image signal of the same polarity is written in the entire pixels belonging to the same row. Regarding the pixel row Y2 for example, an L level image signal is written at both the preceding time shown in FIG. 4A and the following time shown in FIG. 4B.

Subsequently, upon selection of the gate line G3, an image signal is written in the pixels distributed to the pixel rows Y3 and Y4 as shown in FIG. 4C. At this time, the polarity is inverse to that in FIG. 4B, and is therefore the same as in FIG. 4A. As a result, H-level image signals are written in the entire pixels belonging to the pixel row Y3. Thus, in the dot line inversion driving, image signals of inverse polarities are supplied to the mutually adjacent signal lines in the horizontal driving circuit, and the image signal polarity is inverted in accordance with sequential selection of the gate lines G. Consequently, it becomes possible to write image signals of which polarity is inverted alternately per row.

Regarding one pixel column in the dot line inversion driving mentioned above, an H level is written in the preceding pixel, and then an L level is written in the next pixel. In this case, the potential is greatly changed from the H level written in the preceding frame to the L level written thereafter. Since some capacitive coupling is existent between mutually adjacent pixels, there occurs a crosstalk therebetween, so that the H level written in the preceding pixel is varied somewhat due to the great potential change. In order to prevent such a crosstalk, it is preferred to adopt a twice selection method shown in FIG. 2. That is, when an image signal has been written in the first selection, the level is varied somewhat due to the crosstalk, but the crosstalk is compensated immediately since the second writing is executed right after that.

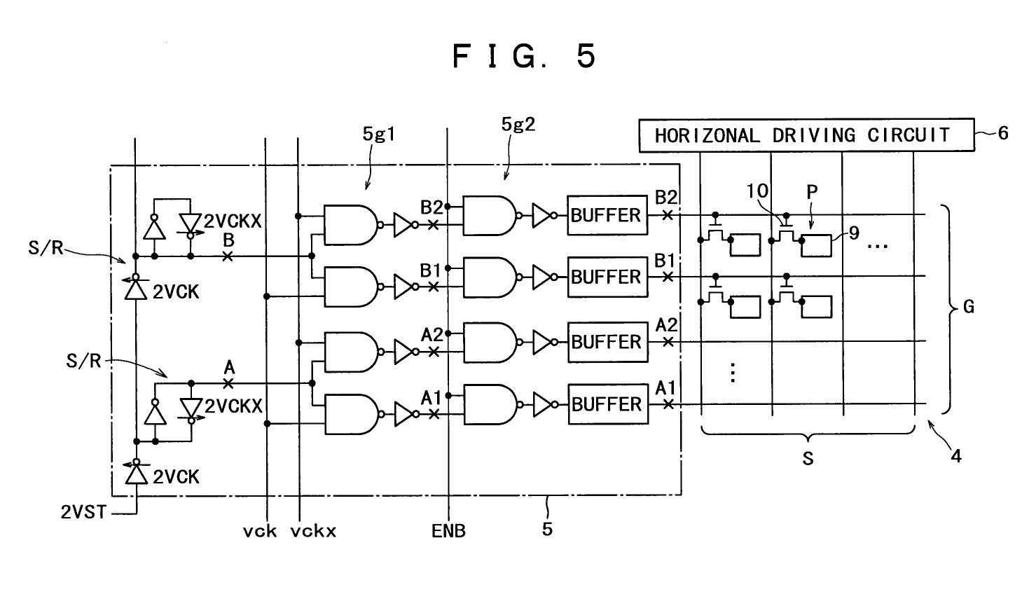

FIG. 5 shows a reference example of a display device, wherein any component parts corresponding to those in the display device of the present invention in FIG. 1 are denoted by the same reference numerals or symbols. In the reference example of FIG. 5, the structure of its vertical driving circuit 5 is different from that in FIG. 1, and no shaping means is provided therein. Because of this relationship, the gate circuit in this reference example has, differing from the single-stage gate circuit configuration shown in FIG. 1, a double-stage structure consisting of a first-stage gate circuit 5g1 and a second-stage gate circuit 5g2. Consequently, the number of NAND elements is rendered double in comparison with those in the structure of FIG. 1. The first-stage gate circuit 5g1 extracts VCK and VCKX in response to shift pulses A, B . . . , and generates drive pulses A1, A2, B1, B2 . . . and so forth. The second-stage gate circuit 5g2 processes the drive pulses A1, A2, B1, B2 . . . in response to ENB, and then outputs the processed pulses A1′, A2′, B1′, B2′ . . . to the gate lines G via buffers.

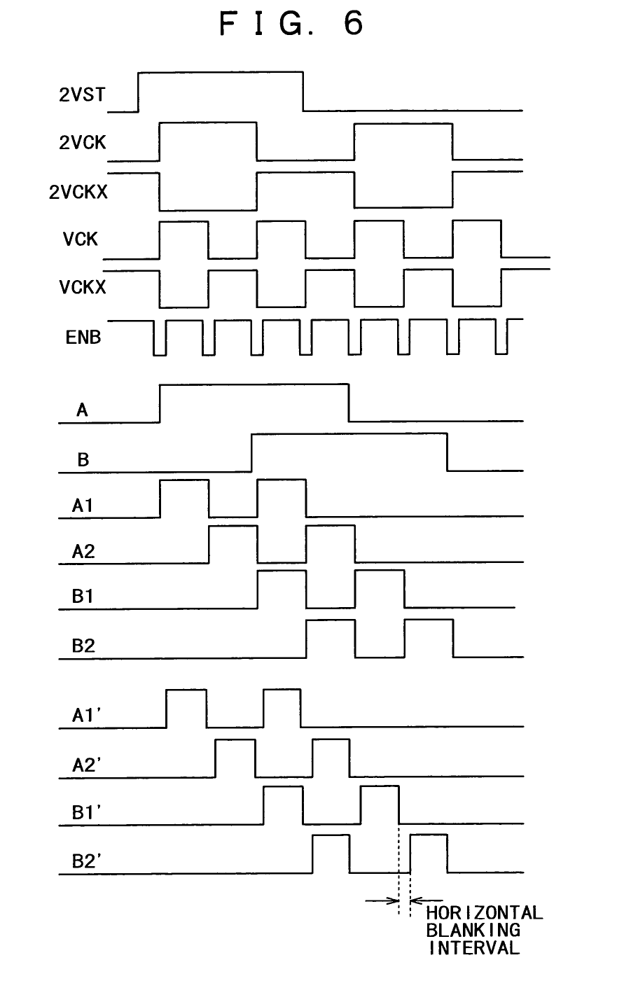

The operation of the reference display device shown in FIG. 5 will be described below with reference to a timing chart of FIG. 6. External pulses 2VST, 2VCK, 2VCKX, VCK, VCKX and ENB are supplied to the vertical driving circuit in the same manner as in the aforementioned display device of the present invention in FIG. 1. The shift register in the vertical driving circuit sequentially transfers 2VST in accordance with 2VCK and 2VCKX, and outputs shift pulses A, B . . . and so forth. The first-stage gate circuit 5g1 in the vertical driving circuit extracts VCK and VCKX in accordance with the shift pulses A, B . . . , and then generates drive pulses A1, A2, B1, B2 . . . and so forth. One NAND element is required per gate line to execute this process. Further, the second-stage gate circuit 5g2 in the vertical driving circuit shapes the drive pulses A1, A2, B1, B2 . . . in response to ENB to thereby generate final drive pulses A1′, A2′, B1′, B2′ . . . and outputs the same to the gate lines respectively. Another NAND element is required per gate line to execute this shaping process. Due to such shaping, the drive pulses supplied to each gate line are partitioned temporally through the horizontal blanking interval. Thus, two NAND elements are required per gate line for generation of final drive pulses according to the clock driving system.

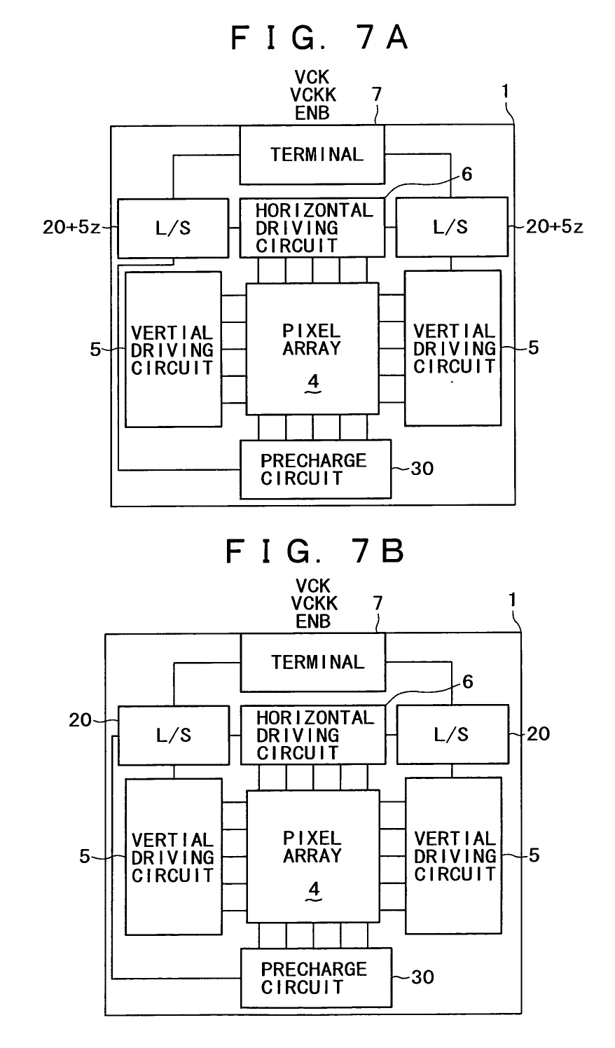

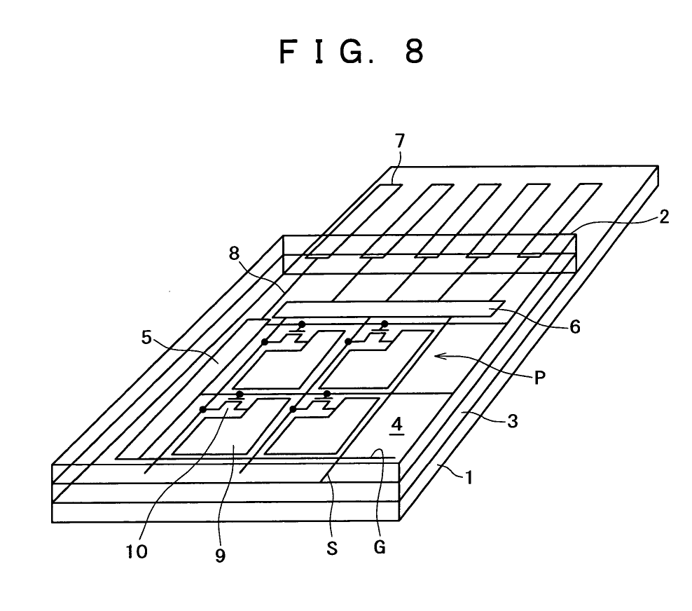

FIG. 7A shows the whole structure of the display device of the present invention in FIG. 1. As shown in this diagram, a pixel array 4, vertical driving circuits 5, a horizontal driving circuit 6, an external connection terminal 7, level shift circuits (L/S) 20, and a precharge circuit 30 are formed integrally on a substrate 1. The pixel array 4 can be driven from both left and right sides by the vertical driving circuits 5. Required pulse signals such as clock pulses VCK, VCKX, ENB and so forth are supplied to the external connection terminal 7. The pulses supplied to the terminal 7 are delivered to the vertical driving circuits 5 and the horizontal driving circuit 6 via buffers after internal control of the voltage level in the level shift circuits 20. In this embodiment, a shaping means 5z attendant to the vertical driving circuit 5 is positioned in a portion of the region where the level shift circuit 20 is formed. The vertical driving circuit 5 scans the pixel array 4 line sequentially, and the horizontal driving circuit 6 writes an image signal in the pixel array 4 synchronously with such scanning. At this time, the precharge circuit 30 precharges the pixel array 4 in advance to the image signal writing executed by the vertical driving circuit 5, thereby suppressing any crosstalk or the like to consequently improve the picture definition.

In this display device, the shaping means 5z positioned within the region of the level shift circuit 20 generates a shaped pulse vck by previously taking a NAND of ENB, VCK and VCKX, and then supplies the shaped pulse to the vertical driving circuit 5. Subsequently, the vertical driving circuit 5 takes a NAND of the vck pulse and the shift pulse to thereby obtain gate line drive pulses having a horizontal blanking interval. According to this system, the number of required internal NAND elements in the vertical driving circuit 5 is reduced from two to one, as compared with the reference example, by using the vck pulses processed through the NAND of VCK, VCKX and ENB. That is, reducing the layout of the vertical driving circuit 5 can be achieved by this system to eventually realize narrow framing of the LCD panel. Since the shaping means 5z to take a NAND of VCK, VCKX and ENB is positioned within the region of the level shift circuit 20 separately from the region of the vertical driving circuit 5, there arises no problem with respect to the space on the layout.

FIG. 7B is a block diagram showing the whole structure of the reference display device in FIG. 5. In order to make it better understood with facility, any component parts corresponding to those in the display device of the present invention shown in FIG. 7A are denoted by the same reference numerals. In this reference display device, as described, a drive pulse corresponding to each signal line is generated by taking a NAND of VCK, VCKX and the shift pulse generated by one stage of the shift register. Further, a NAND of a gate pulse and ENB is taken for partitioning the drive pulses by a horizontal blanking interval. Thus, in the reference example, a final drive pulse is generated by taking a NAND in two stages with regard to the shift pulse, and therefore two NAND elements are laid out per gate line in the vertical driving circuit. For the purpose of curtailing the cost of the LCD panel, it is requisite to raise the panel production efficiency by reducing the frame size of the panel. In view of this point, the vertical driving circuit in the reference display device requires two NAND elements per gate line. The layout width of each NAND element is approximately 200 μm or so, which occupies 13% of the entire layout width of 1500 μm in the vertical driving circuit 5. Therefore, the NAND elements are component parts occupying most of the layout width. In the reference example where two NAND elements are used per gate line, the peripheral frame portion surrounding the pixel array 4 is rendered wider to be consequently disadvantageous with respect to the cost.

### Industrial Availability

In the display device of the present invention, as described hereinabove, clock pulses supplied externally from outside of the panel are shaped collectively by a shaping means provided in the panel, and then are delivered to the gate circuits in the vertical driving circuit, whereby the necessity of shaping the clock pulses in each stage of the gate circuits can be eliminated to eventually realize reduction of the number of required logical elements constituting each stage of the gate circuits. As a result, it becomes possible to reduce the occupied area of the entire vertical driving circuit inclusive of the shift registers, gate circuits and so forth.

1. A display device comprising, on one substrate, a pixel array composed of a plurality of gate lines, a plurality of signal lines, and pixels arrayed to form a matrix at the intersections of said gate lines and signal lines; a vertical driving circuit for sequentially selecting the pixels via said gate lines; and a horizontal driving circuit for writing image signals in the selected pixels via said signal lines;
wherein said vertical driving circuit has shift registers so disposed that one stage thereof corresponds to at least two gate lines, and outputting shift pulses sequentially from the respective stages thereof; gate circuits for generating drive pulses by extracting, in response to the shift pulses, the clock pulses supplied thereto externally, and outputting the drive pulses to the gate lines to sequentially select the pixels; and a shaping means for shaping the clock pulses previously in response to a horizontal blanking pulse supplied externally in synchronism with a horizontal blanking interval, and supplying the shaped clock pulses to said gate circuits.

2. The display device according to claim 1, wherein said shaping means is formed in a different region separate from said shift registers and said gate circuits.

3. The display device according to claim 1, wherein said pixel array is so formed that at least two rows of said gate lines are disposed as a unit between mutually adjacent pixel columns, and said horizontal driving circuit writes image signals of mutually opposite polarities via the signal lines in the mutually adjacent pixels connected to the same gate line.
